(19) United States
(12) Patent Application Publication
(10) Pub. No.: US 2023/0316189 A1
(43) Pub. Date: Oct. 5, 2023

(54) PERFORMING EXPERIMENTS FOR A WORKFORCE ANALYTICS SYSTEM

(71) Applicant: The Fin Exploration Company, San Francisco, CA (US)

(72) Inventors: Alec DeFilippo, San Francisco, CA (US); Uffe Hellum, Seattle, WA (US); Matt Jiang, Rancho Palos Verdes, CA (US); Casey Hungler, Houston, TX (US); Stephen Gross, Pittsburgh, PA (US); Spencer Richard Smith, San Francisco, CA (US); Andrew Jordan, San Francisco, CA (US)

(21) Appl. No.: 17/709,219

(22) Filed: Mar. 30, 2022

(51) Int. Cl. G06Q 10/06; G06Q 30/00; G06Q 10/10

(52) U.S. Cl. CPC G06Q 10/0633; G06Q 30/016; G06Q 10/101; G06Q 10/103; G06Q 10/1091

(57) ABSTRACT

Methods, systems, and apparatus, including computer programs encoded on computer storage media, for performing an experiment for a workforce analytics system. One of the methods includes identifying team members who conduct work using a heterogeneous set of software tools including third party software tools. An experiment group of team members and a control group of team members are identified. Experiment activity data is received from use by the experiment group of the set of heterogeneous software tools and control group activity data is received from use by the control group of the set of heterogeneous software tools. A metric by which to measure the effect of a process change is identified. The effect of the process change is determined according to the metric and based on the experiment activity data and the control group activity data. Action is taken based on the effect of the process change.

### BACKGROUND

### Technical Field

This specification relates to performing an experiment for a workforce analytics system.

### Background

Computer users often multitask, doing multiple things at once. A computer user may be a customer support agent who may split their time across multiple cases, such as to provide support to customers phoning in or using a chat box to obtain support. The customer support representative may spend different portions of time helping each of the customers. The customer support representative may also perform other actions on the computer that are not related to any of the customers' cases.

### SUMMARY

This specification describes technologies for performing an experiment for a workforce analytics system.

In general, one innovative aspect of the subject matter described in this specification can be embodied in methods that include the actions of: identifying team members who conduct work using a heterogeneous set of software tools including third party software tools; identifying, based on inclusion criteria for an experiment, an experiment group of team members and a control group of team members; receiving experiment activity data from use by the experiment group of team members of the heterogeneous set of software tools; receiving control group activity data from use by the control group of team members of the heterogeneous set of software tools; identifying a metric by which to measure the effect of a process change; determining the effect of the process change according to the metric and based on the experiment activity data and the control group activity data; and taking action based on the effect of the process change.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Experiments can be performed for a workforce analytics system, including support for both pre/post experiments for a same group of users or an AB experiment for comparing different groups of users. Various types of actions can be performed in response to experiment results, including automatic providing of recommendations and other automatic actions, as described below. Experiments can be performed in an automated fashion in environments where manual experiments are impractical if not impossible. For example, experiments can be performed for workforces that include, for instance, thousands of users. As another example, experiment results can include tracked activity that can include many thousands of data points based on tracking user activity and events for a variety of heterogeneous tools. Activity can be tracked per user for numerous tools. For example, a given user may use twelve, fifteen, or some other number of heterogeneous tools, including third party tools, while performing their work. Experiment results can be updated and provided on an ongoing basis. A stakeholder, such as a manager, can be automatically provided experiment results. Accordingly, stakeholders can more quickly make decisions regarding whether to more broadly implement a process change (e.g., beyond an experiment group). A process change can be implemented if the experiment results show that improved performance is achieved. Improved performance that occurs from implementing a change that was a focus of an experiment can result in resource savings (e.g., by achieving a same amount of work in less time, using less computing resources, etc.). Operations leaders can be enabled to test changes to the way different types of customer issues are resolved and receive information that indicates increases, decreases, or a neutral effect for key metrics such as utilization, efficiency, and handle time. Running experiments with the experiment system can reduce risk associated with change implementation and also enable leaders to tweak changes before rolling out changes to an entire team, thereby delivering improved return on investment for change management. The experiment system can bring the power of testing to operations and customer service workflows, allowing teams to continuously improve processes. Other advantages are described below.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of a workforce analytics system that can be used to determine discrete time spent by customer service agents on different tasks across different systems and produce reports based on discretized time, according to some implementations of the present disclosure.

FIG. 1B shows an example of a workforce analytics manager (WAM), according to some implementations of the present disclosure.

FIG. 2 is a screenshot of a customer screen for handling cases in the workforce analytics system 100, according to some implementations of the present disclosure.

FIG. 3 is a flowchart of an example of a method for determining time spent by the customer service agent on the particular case, according to some implementations of the present disclosure.

FIG. 4 is a block diagram illustrating an environment that includes a true utilization engine.

FIG. 5 is a diagram that illustrates case session tracking for a workforce analytics system.

FIG. 6 is a block diagram illustrating an example system for performing experiments for a workforce analytics system.

FIG. 7 illustrates an example system for AB experiments.

FIG. 8 illustrates an example system for pre-post experiments.

FIG. 9 illustrates an example user interface for starting a new experiment.

FIG. 10 illustrates an example user interface for providing experiment details for a pre-post experiment.

FIG. 11 illustrates an example user interface for providing information for establishing an experiment timeline for a pre-post experiment.

FIG. 12 is an example graph that depicts experiment results for an example pre-post experiment.

FIG. 13 illustrates an example dashboard user interface for pre-post experiments.

FIG. 14 illustrates an example user interface for providing experiment details for an A/B experiment.

FIG. 15A is an example user interface for configuring an experiment timeline for an A/B experiment.

FIG. 15B is an example graph that depicts experiment results for an example A/B experiment.

FIG. 16 illustrates an example dashboard user interface for A/B experiments.

FIG. 17 is a flowchart of an example of a method for performing an experiment for a workforce analytics system.

FIG. 18 is a block diagram of an example computer system used to provide computational functionalities associated with described algorithms, methods, functions, processes, flows, and procedures described in the present disclosure.

Like reference numbers and designations in the various drawings indicate like elements.

### DETAILED DESCRIPTION

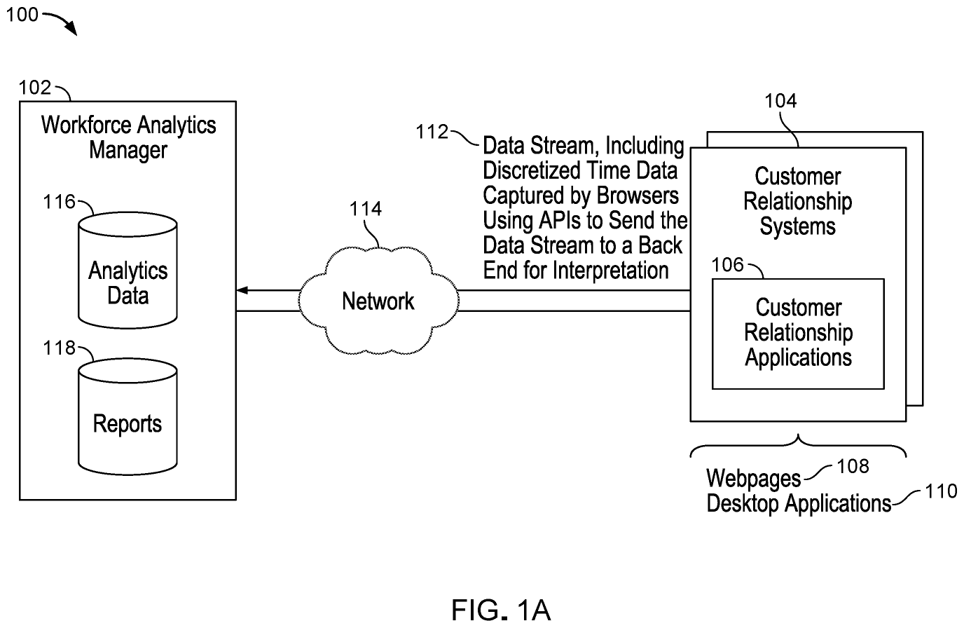

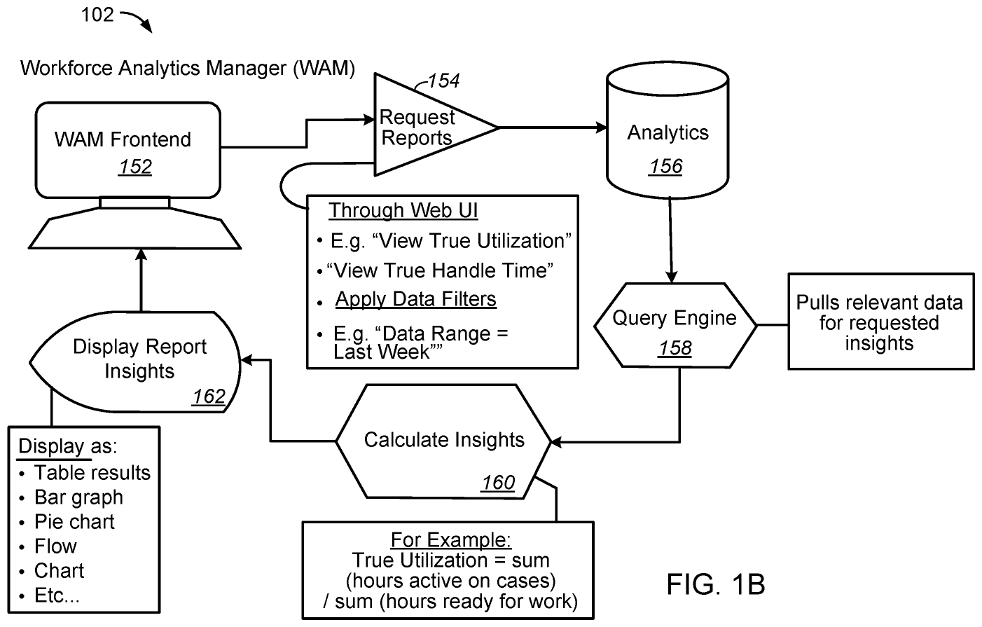

The following detailed description describes techniques for performing an experiment for a workforce analytics system. FIGS. 1A to 5 provide an overview of the workforce analytics system and approaches for discretizing time spent by users (e.g., customer service agents) doing specific tasks on computers. Further details of the workforce analytics system are described in application Ser. No. 17/219,588, filed Mar. 31, 2021, which is incorporated by reference in its entirety.

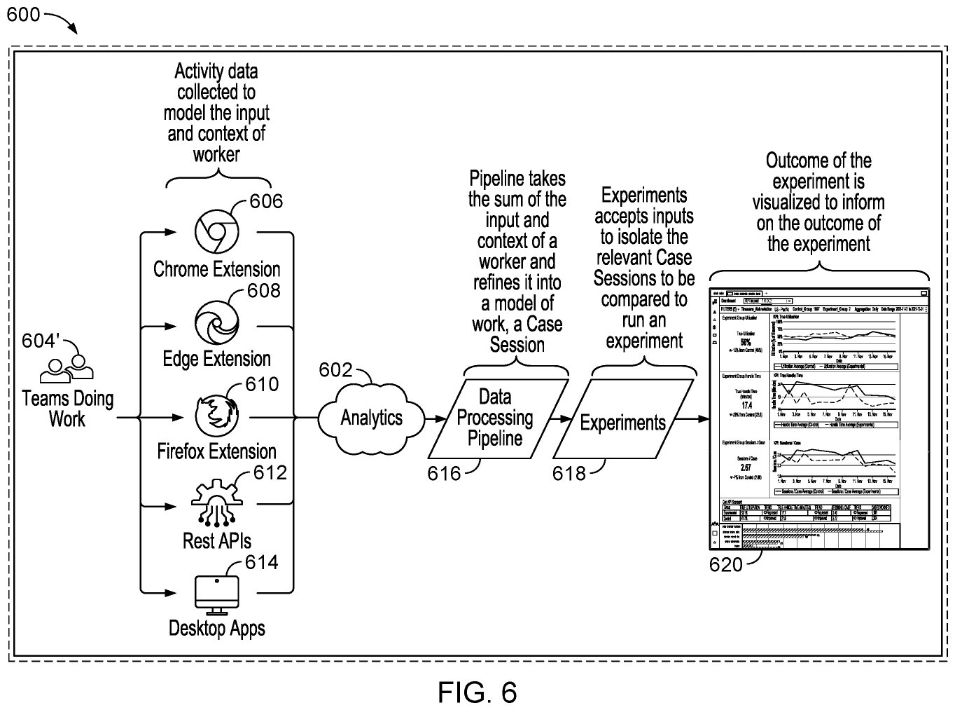

FIGS. 6 to 17 provide details for performing experiments. An experiment system can provide an experimental framework that can enable teams of humans working at computers to understand if changes to tools, processes, or training are making an impact on key team output measures. The experiment system can enable team managers to make detailed and scientific evaluations of changes which enables more effective management than other ad hoc or manual approaches to experimentation. With the experiment system, an operation team can define a hypothesis to be tested, select an experiment group to include in an experiment, and specify an experiment duration. Based on the parameters of the experiment, the experiment system can compare experiment group activity to control group activity and generate, for example, a customized dashboard that compares the impact of the experiment as compared to a status quo. The experiment system can be used by any team of people doing work with computers. An example application is for customer service teams doing ticket based work. However the experiment system solution can be applied and used for sales teams, accounting teams, software engineering teams, or any other team that accomplishes work at a computer.

As described below, the experiment system can use data that is collected by a workforce analytics system. A workforce analytics system is a work insights platform that includes a web browser extension that can collect information about which web pages and tools are used by a team of workers, how much time the workers spent using those web pages and tools, and how engaged the workers were with those tools and web pages. The data provided by the workforce analytics system can be used by the experiment system to compare, for example, either one group of workers' metrics against the same group of workers' in a different time period (e.g., a pre-post experiment) or to compare two groups of workers against each other (e.g., in an A-B experiment).

Use of the experiment system can enable an organization to make informed decisions by providing information that can be used to answer important questions about use of tools by a workforce. For instance, with the experiment system, operations and customer support leaders can answer questions such as “Do our new knowledge base articles reduce context switching?” or “How do our new templates impact handle time?” or “Did my team's handle time improve after I implemented skills-based routing?” or “Is this new tool we rolled out to one team streamlining our workflow so that we can justify rolling it out to all teams?”, to name a few examples.

Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

FIG. 1A shows an example of a workforce analytics system 100 that can be used to determine discrete time spent by customer service agents on different tasks across different systems and produce reports based on discretized time, according to some implementations of the present disclosure. The workforce analytics system 100 includes a workforce analytics manager 102 that interfaces with one or more customer relationship systems 104. Each customer relationship system 104 includes one or more customer relationship applications 106, such as CRM systems. Users (such as CRM agents) can use the customer relationship system 104, for example, by accessing webpages 108 and using desktop applications 110.

While an agent is using the customer relationship systems 104, a data stream 112 is sent to the workforce analytics manager 102 for interpretation. The data stream 112 can include discretized time data captured by browser extensions using APIs to send the data stream to a back end for analysis. The workforce analytics manager 102 can store the received data stream 112 as analytics data 116. The workforce analytics manager 102 can use the analytics data 116 to generate reports. Components of the workforce analytics system 100 are connected using a network 114 that includes, for example, combinations of the Internet, one or more wide area networks (WANs), and one or more local area networks (LANs).

Examples of reports that can be produced using discretized time data can include focus events. Focus events can be used, for example, to assign each action performed by an agent to a single “case.” An action that is assigned to a case can be disambiguated from actions performed on other cases. Discretizing the time and assigning events to specific cases can be based on cross-platform tagging for each active session. Automatic matching can occur, for example, when an agent opens a specific document within a specific period of time after opening a case. The automatic matching can use agent behavior pattern recognition that incorporates logic for timeouts, accesses to specific pages and documents, and automatic linking of identifiers from disparate systems.

The workforce analytics system 100 can perform tracking in the context of multiple workflows and multiple customers. For example, a customer service agent may have a workflow to provide a customer refund that requires the customer service agent to access a number of different systems. Based on a list or pattern of the different systems necessary for a particular type of task, workforce analytics system 100 can insure that the customer service agent follows a proper procedure while collecting metadata from each system that the customer service agent accesses and linking the metadata together.

A customer service agent may be handling multiple, simultaneously customer service cases (for example, chats) at once. Even though the time is overlapping for each of the associated customers, the workforce analytics system 100 can determine how much of their time is actually spent on each customer. The time that is tracked includes not only how much time the customer service agent is chatting with that customer, but how much time the customer service agent is spending working on that customer versus working on actions associated with another customer. The workforce analytics system 100 can use clustering algorithms and other techniques to identify that an agent is working on the same case across different systems. The clustering can occur, for example, using text copied from one box into another and based on patterns of access of different systems when handling a case.

FIG. 1B shows an example of the workforce analytics manager (WAM) 102 of FIG. 1A, according to some implementations of the present disclosure. The WAM 102 includes a WAM front end 152 that provides a user interface for a user to request reports 154, for example, using analytics data 156. Report requests 154 can be made by a user through a web user interface (UI). Example reports can include viewing true utilization and viewing true handle time. As described in more detail below, true utilization can be determined as a sum of productive time divided by available work time. True handle time can measure an average amount of team member time spent on a case. Using the UI, the user can apply filters, including user filters and date filters (e.g., date range=last week). The analytics data 156, including user actions and event data, can serve as data input to a query engine 158 accessible through the UI for accessing relevant data for requested insights. Calculated insights 160 can be used to display report insights 162. For example, for a report providing true utilization (including user efficiency and time spent on cases), the insights can be used to create a ratio of hours active on cases and hours ready for work. Displayed reports can be displayed, for example, as table results, bar graphs, pie charts, and flow charts.

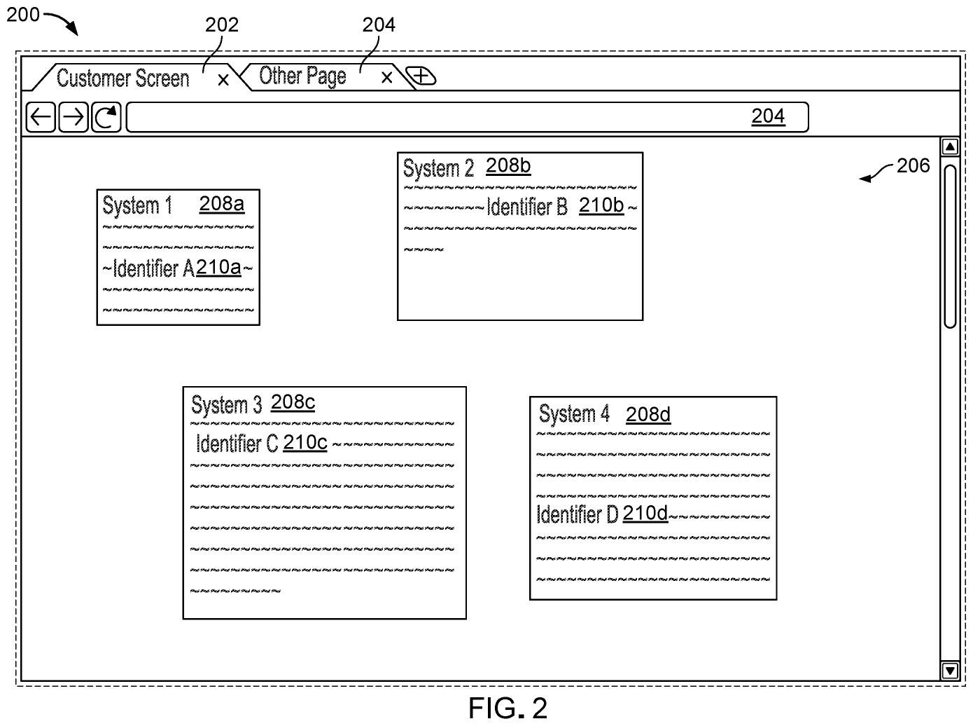

FIG. 2 is a screenshot 200 of a customer screen 202 for handling cases in the workforce analytics system 100, according to some implementations of the present disclosure. The customer screen 202 can be an interface used by a user (for example, a customer service agent). The customer screen 202 can be one of many screens available and used in the user's browser or on the user's desktop to handle cases, including another page 204 that may present a user interface for specific products or services. An originating call, such as a chat, may originate on the customer screen 202 used by an agent. The agent may immediately or subsequently navigate to other resources, such as other pages 204, to look up the customer or perform some other action related to the case.

Working areas 206 in customer screens 202 and other pages 204 can include several pages 208a-208d (or specific screens), accessible through browsers, for example, each with corresponding identifiers 210a-210d. Other resources accessed by the customer service agent can include documents such as word documents and spreadsheets for presenting and recording information associated with a case. The identifiers 210a-210d may be completely different across the systems associated with the pages 208a-208d. However, the workforce analytics system 100 can use the analytics data 116 to associate an identifier with work done on various uncoordinated systems, which in turn can link together time spent on those different systems for the same case. The various uncoordinated systems can provide multiple software services such as web pages, documents, spreadsheets, workflows, desktop applications, and conversations on communication devices. The multiple software services include at least a software service of a first type and a software service of a second type, where the software service of the first type and the software service of the second type are uncoordinated software services lacking inter-service communication and a common identification labelling system.

In some implementations, the following steps can be used for assigning an event to a case. First, the system determines a location of a case ID or other identifier. For example, the identifier may only be seen on webpages matching specific Uniform Resource Locator (URL) patterns or using specific desktop apps. Such identifiers can be extracted from the URL, from a page/app title, or from a specific region in the HTML hierarchy of the webpage.

Each website or desktop app where an ID can be extracted is known as a service. By associating observed identifiers together with multiple services, events from multiple services can be associated together under a single case ID. The case ID can originate from whichever service the system determines to be the primary service.

To associate a first identifier with a second identifier, a sequence of events can be defined that represents the observation of identifiers in a particular order, within a bounded time-frame. The system can use this defined sequence of events to link events and their respective identifiers. Such a defined sequence can be a sequence of pages, for example, that are always, or nearly always, visited, in order and in a time pattern, when a new case is originated and handled by a customer service agent. Whenever a linked identifier is determined, that event and any subsequent events are associated with the case as identified by the identifier from the primary service.

In a working example, consider a customer service agent that engages in multiple simultaneous chats and uses a separate CRM service to look up customers and make changes to their accounts. Since the customer service agent switches between the chat windows and the CRM service, there is a need to know, specifically, how much time is spent on each customer and case. The following sequence of events can be defined.

First, the customer service agent receives a new chat box, for example, entitled “Chat 123” on a website that is considered as the primary service. The new Chat ID 123 is created, and the Case ID is marked with the Chat ID. Second, within a threshold time period (e.g., 60 seconds), the customer service agent searches the CRM system for the customer.

Third, within another 60 seconds, the customer service agent lands on the customer's page within the CRM that matches the URL pattern (for example, crm.site.com/customers/234). The CRM ID 234 is recognized, and the ID 234 is linked with Case ID 123.

Fourth, the customer service agent responds to another customer and enters a chat box, for example, with Chat ID 567. This action and subsequent actions in this chat box are not associated events with Chat 123, but instead are associated with Chat 567.

Fifth, the customer service agent goes back to the CRM system on page crm.site.com/customers/234. This surfaces CRM 234 which is linked with Chat 123, associating that event and subsequent events with case 123 until the next time case 123 is interrupted.

Note that, if the customer service agent performs other events at the same time as the sequence of events described above, such additional events do not affect the system's ability to recognize system operation. This is because certain implementations do not require that the set of events is exclusively limited to the chat and CRM events noted above.

In some implementations, the functionality of the techniques of the present disclosure can be represented in pseudocode. Code corresponding to the pseudocode shown below can be executed by a browser extension that is part of the workforce analytics system 100, for example. Different types of browser extensions are shown below with respect to FIG. 6. Assume that event stream is a variable that represents a time-ordered list of the following types of events: 1) webpage visits with URLs and page titles, 2) desktop application window events with page titles, and 3) clicks, events, and interactions within a web page on a particular webpage element or region that has its own descriptors. A case ID can be defined as any identifier associated with a service that is the primary tool used for customer communications. In such a case, pseudocode describing operation of the workforce analytics manager of FIG. 1A can include:

```
identifier_mappings = <Mapping of Case ID to list of linked identifiers>
all_possible_sequences = <List of event sequences already in process for
each rules pertaining to possible sequences of events>
current_case_id = None
for event in event_stream:
  for current_sequence_step in all_possible_sequences:
    if current_sequence_step.matches(event):
      identifiers = current_sequence_step.get_identifiers(
        event.page_title,
        event.url,
        event.html
      )
      current_sequence_step.move_to_next_step( )
      current_case_id = current_sequence_step.get_case_id( )
      # If current_case_id cannot be resolved this way look
      # for a mapping
      If not current_case_id:
        current_case_id = [
        key for (key, existing_identifiers) in identifier_mappings
        if identifiers intersects existing identifiers
        ]
      if current_case_id:
      identifier_mappings[current_case_id].append(identifiers)
  event.case_id = current_case_id (attribute event to Case ID)
```

At a high level, the pseudocode links events (e.g., customer service agent actions) to corresponding cases and captures event information (e.g., clicks, customer service agent inputs) for the events, e.g., by stepping through a sequence of events that have occurred.

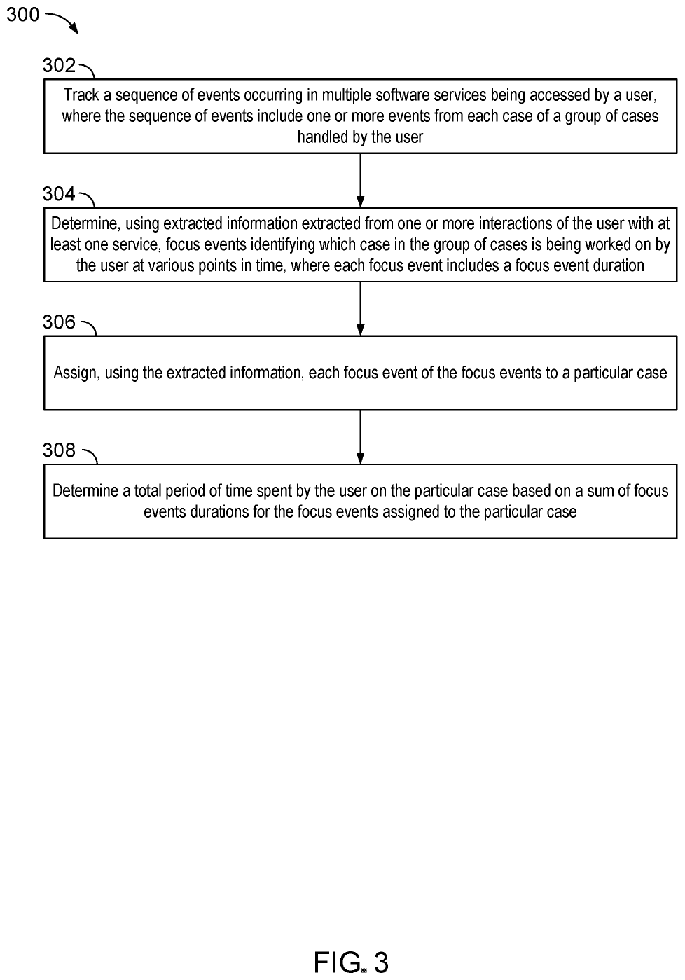

FIG. 3 is a flowchart of an example of a method 300 for determining time spent by the customer service agent on the particular case, according to some implementations of the present disclosure. For example, the system 200 can be used to perform the method 300. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, a sequence of events occurring in multiple software services being accessed by a user (e.g., a customer service agent) is tracked. The multiple software services can include web pages, documents, spreadsheets, workflows, desktop applications, and conversations on communication devices. As an example, the multiple software services can include web pages used by the user within a CRM system, and the user can be a customer service representative. The sequence of events includes one or more events from each case of a group of cases handled by the user. In some implementations, the multiple software services can include at least a software service of a first type and a software service of a second type, where the first type is CRM software and the second type is a search engine.

Focus events are recorded that identify page switches by the customer service agent, views of a new resource by the customer service agent, where each focus event identifies the customer service agent, an associated case, an associated session, a time spent on a particular page, whether the particular page was refreshed, keys that were pressed, copy-paste actions that were taken, and mouse scrolls that occurred. Heartbeats are recorded at a threshold heartbeat interval (for example, once every 60 seconds). The heartbeats can indicate CPU performance and whether the customer service agent has been active (and to what degree). Page load events are recorded including identifying a time to process a page load request, a time to finish loading the page, a number of tabs that are open, and whether a page load was slow. DOM events are recorded, including clicks by the customer service agent, scrolling by the customer service agent, an identifier of a software service, a class name and a subclass name of the software service, and content of text typed into the software service.

In some implementations, tracking the sequence of events can include setting identifier threshold rules defining a set of identifiers used in a set of systems that are to be tracked, disregarding identifiers not included in a tracked subset of the multiple software services, recording timestamps for start and end times on a particular software service, and disregarding, using the start and end times, identifiers corresponding to events that last less than a threshold event duration.

In some implementations, tracking the sequence of events can include collecting active page events, page level events, machine heartbeats, DOM events, video, audio, times when the customer service agent is speaking versus not speaking, times when the customer service agent is using video, entries written to documents, desktop application events, and entries extracted from the documents. From 302, method 300 proceeds to 304.

At 304, focus events identifying which case in the group of cases is being worked on by the customer service agent at various points in time are determined using information extracted from one or more interactions of the customer service agent with at least one service, where each focus event includes a focus event duration. From 304, method 300 proceeds to 306.

At 306, each focus event of the focus events is assigned to a particular case using the extracted information. For example, assigning each focus event of the focus events to a particular case can include linking previously unlinked identifiers from the software services by observing an expected behavioral pattern for using the multiple software services in a particular order pattern to respond to and close the particular case. In some implementations, the expected behavioral pattern can be company-dependent. In some implementations, the expected behavioral pattern can include ICIs including a timeframe defining an amount of time between a start time of the particular case and a next step performed by the customer service agent on the particular case. From 306, method 300 proceeds to 308.

At 308, a total period of time spent by the customer service agent on the particular case is determined based on a sum of focus event durations for the focus events assigned to the particular case. As an example, assigning a focus event to the particular case can include using clustering algorithms to identify and cluster a same customer corresponding to the particular case across the multiple software services. After 308, method 300 can stop.

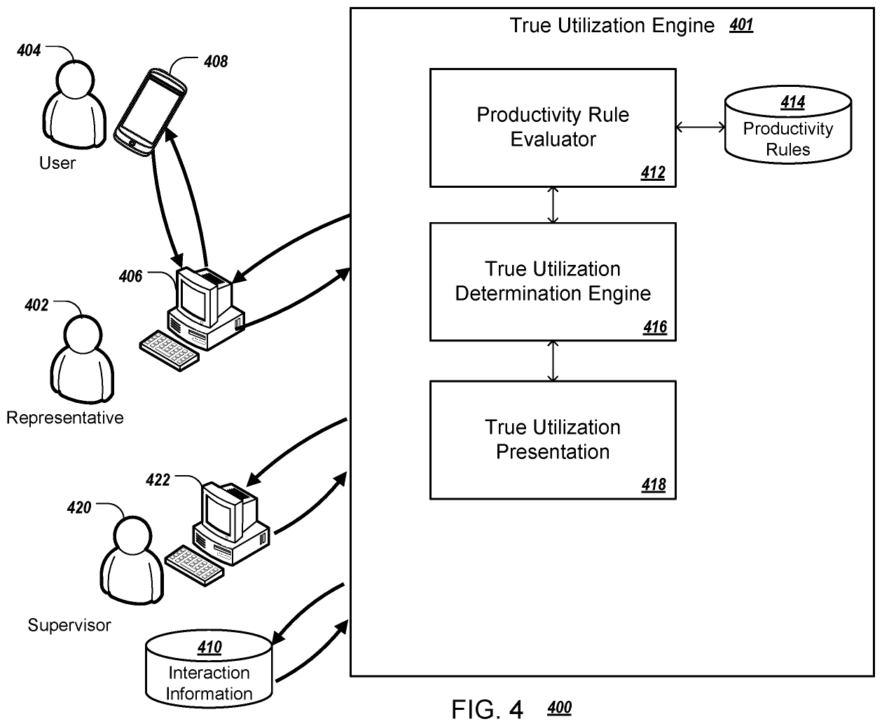

FIG. 4 is a block diagram illustrating an environment 400 that includes a true utilization engine 401. The true utilization engine 401 can be a part of the workforce analytics manager 101, for example. As described above, support representatives, such as a support representative 402, can provide support for users, such as a user 404. The support representative 402 can perform support interactions using a computing device 406 and/or other devices(s). The user 404 can contact a support system using a device 408, which may be a smartphone as illustrated (e.g., using a voice call and/or browser or application connection) or some other type of device.

The true utilization engine 401 (or another system) can retrieve interaction information 410 that describes interactions that occur during various support cases for the support representative 402 for a particular time period (e.g., day, week, month). The true utilization engine 401 can also obtain timing data for the support representative 402 that indicates available work time for the support representative 402 during the time period.

A productivity rules evaluator 412 can evaluate productivity rules 414 that have been defined or configured for an organization of the support representative 402 (or in some cases learned by a machine learning engine). The productivity rules 414 can include conditions defining productivity of interactions by users of the organization. The productivity rule evaluator 412 can evaluate the productivity rules 414 with respect to the interaction information 410 for the support representative 402 to determining productivity of the interactions taken by the support representative 402 during the time period.

A true utilization determination engine 416 can determine true utilization for the support representative 402 based on the productivity of the interactions and the available work time for the support representative 402 during the time period. For example, the true utilization determination engine 416 can determine true utilization by determining a sum of productive time and dividing the sum of productive time by the available work time. A true utilization presentation component 418 can present true utilization information, such as to a supervisor 420 on a supervisor device 422. Other outputs can be produced and other actions can be taken, by the true utilization engine 401 or by other system(s), based on determined true utilization information.

In further detail regarding the true utilization engine 401, previous systems for tracking operator time have historically not had a method for accurately and automatically converting employee actions into a measure of productivity without manual oversight. Previous solutions include manual shadowing and tabulation of employee activities (e.g., time-in-motion studies). Time-in-motion studies are manual processes that can only be applied while a human observer is available to observe, so samples may be limited and additional resources (e.g., the human observer) are required.

Other previous solutions involve manual time tracking (e.g., employees self-reporting on timesheets), or naïve, imprecise, and only partial time tracking performed using software with tracking restricted to the user's time within only that software's own system. Some prior solutions only observe time spent within the software's direct system or predefined partner systems, so organizations lack visibility into a full operator work day and corresponding actions. Some previous solutions only track time, not actions, and not more refined tracking such as productive actions. Additionally, previous software systems do not categorize work into productive or other buckets, rather naively assuming all time spent within their system is to be counted, or relying on the operator to manually indicate their status (which is highly inaccurate, inconsistent, and subjective).

To solve the above and other problems, the true utilization engine 401 can be used to analyze each operator or representative action and compare the action against historical data, learned models, and any prescribed action categorization by the operator's employer, to determine whether the action is productive. For example, sending replies to customer tickets within a case management system may get categorized as productive but typing personal emails may get categorized as unproductive. As another example, entering bug reports within an internal system may get categorized as productive. Reading blogs on unsanctioned websites may get categorized as unproductive while reading articles within a knowledge base can be categorized as productive.

True utilization metrics can be calculated to determine what percentage of a day a representative is performing productive work, such as actively working on a case and engaged productively with approved or recommended tools in order to solve the case. True utilization can be used in any digital work environment where human operators perform tasks. True utilization can be calculated across each system, application or service an operator uses, rather than within a single system or selected applications. True utilization can be used to aid understanding of whether operator actions are productive relative to the operator's broader tasks at hand such as assigned cases.

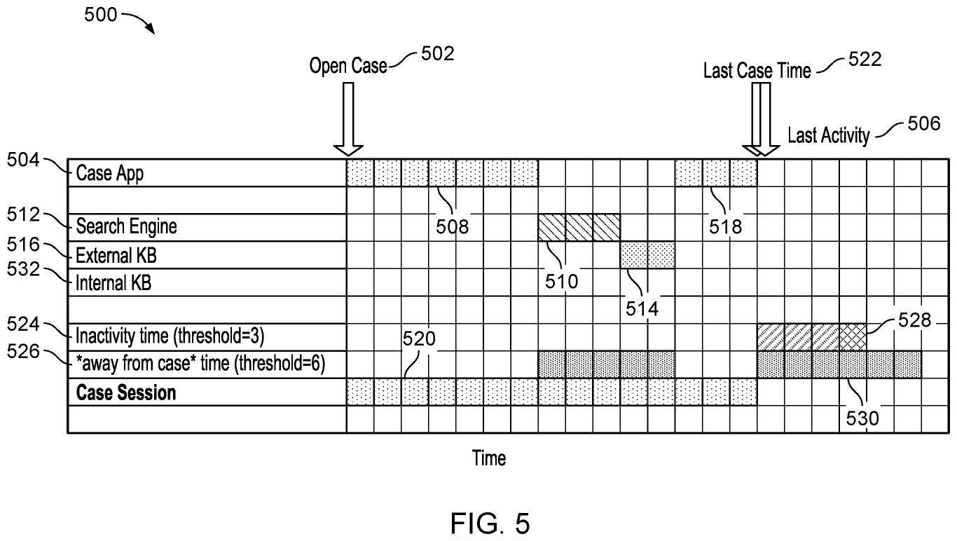

FIG. 5 is a diagram 500 that illustrates case session tracking for a workforce analytics system. The diagram 500 includes depiction of squares that each represent a time unit of activity for a user starting at a first time point 502 corresponding to first activity for a case in a case application 504 up until a last activity 506 for the user for the case, with squares plotted on the left side of the diagram 500 representing earlier activity than squares that are plotted on the right side of the diagram 500. Each square can represent a particular time unit, such as one minute, for example.

The case application 504 may be configured as a case-defining service, for example. A user may have opened a case for a customer in the case application 504. A set of seven squares 508 represents seven units of time of activity for the case for the user in the case application 504. A set of three squares 510 represents three units of time that the user spent using a search engine 512. A set of two squares 514 represents two units of time that the user spent using an external knowledge base (KB) 516. A set of three squares 518 represents three units of time that the user spent using the case application 504 (e.g., after returning to the case application 504).

A case session is represented in the diagram 500 as a set of squares 520, which correspond, timewise, to the activity described above for the case application 504, the search engine 512, and the external knowledge base 514. The workforce analytics system (which can be the workforce analytics system 100) can determine the end of the case session based on a last case time 522 for the case. The workforce analytics system can determine the last case time 522 based on an inactivity time threshold 524 and/or an away-from-case time threshold 526. For example, the workforce analytics system can determine the last case time 522 based on a period of inactivity (e.g., represented by a set of squares 528) that is more than the inactivity time threshold 524. As another example, the workforce analytics system can determine the last case time 522 based on a period of time away from the case (e.g., represented by a set of squares 530) that is more than the away-from-case time threshold 526.

Time away from the case can be defined as periods of time in which the user is not using the case application 504 after the opening of the case. The time spent by the user using the search engine 512 and then the external knowledge base 516 (e.g., represented by the sets of squares 510 and 514, respectively) can be counted as part of the case session based on a sum of time spent away from the case application 504 being less than the away-from-case time threshold 526.

The workforce analytics system can determine time spent in each of the case application 504, the search engine 512, the external knowledge base 516 and other tools or applications (e.g., an internal knowledge base 532) by monitoring events received from the various tools and applications. The workforce analytics system can define and manage a data model that incorporates and stores event information and derived information such as case-related activity, activity not related to a case, and inactivity information that is determined from the event information. As described in more detail below, an experiment system can be incorporated into or integrate with the workforce analytics system to measure experiment-related activity and non-experiment-related activity, using the data model provided by the workforce analytics system.

FIG. 6 is a block diagram illustrating an example system 600 for performing experiments for a workforce analytics system. A workforce analytics system 602 (which can be the workforce analytics system 100) can collect activity data of workers 604 who may be on various teams. The workforce analytics system 602 can collect activity data to model input and context of the workers 604. For example, the workforce analytics system 602 can receive activity data, for the workers 604, from a first type of browser extension 606 (e.g., a Chrome™ browser extension), a second type of browser extension 608 (e.g., an Edge™ browser extension), a third type of browser extension 610 (e.g., a Firefox™ browser extension), other types of browser extensions, a REST (REpresentational State Transfer) API 612, and desktop application(s) 614. The REST API 612 can be used by applications to send arbitrary point events to the analytics system 602.

The workforce analytics system 602 can include or use a data processing pipeline 616 that accepts as input the activity data for the workers 604 that represents worker input and context. The data processing pipeline 616 can refine the activity data into a model that represents and describes the work of the workers 604. The model can include case session information that is derived from the activity information, for example.

In summary, the workforce analytics system 602 can receive information regarding the work that the workers 604 perform at computers and the data processing pipeline 616 can process that data to generate a variety of data points. The data processing pipeline 616 can generate a data model of human attention and activity that can model what the workers 604 are focused on for any given amount of time, whether the workers 604 are actively working or not actively working, and workflow activity between various tools as the workers 604 complete tasks. The data model can include input contact intervals, distilled focus events, and distilled case session information. The data model generated by the data processing pipeline can provide a broad representation across an entire team of the processes used for executing work for the team.

An experiment system 618 can accept as input information that can isolate relevant case sessions represented in the data model to use in an experiment. For example and as described in more detail below, the experiment system 618 can accept inputs that define different groups of workers 604 to be used for an AB experiment, such as a test group that has that performs a process change to be tested and a control group that does not perform the process change to be tested. As another example, the experiment system 618 can accept as input a test group of workers and an implementation date of a change that was implemented for the test group for a pre-post experiment.

The experiment system 618 can identify relevant case sessions for the experiment based on received inputs. For example, for an A/B experiment, the experiment system 618 can determine case sessions for the test group and case sessions for the control group. As another example, for a pre-post experiment, the experiment system 618 can determine case sessions for the test group that occurred before the change was implemented and cases sessions for the test group that occurred after the change was implemented.

As described in more detail below, the experiment system 618 can determine or access various metrics for the different experiment groups. The experiment system 618 can generate various visualizations 620 that be used to inform stakeholder(s) about the results of the experiment. As an example, the experiment system 618 can generate a KPI (Key Performance Indicator) impact dashboard that can present core metrics related to activity of the workers 604 including visualizations of changes over time for the KPIs for a pre-post experiment or differences for the KPIs between two groups for an A/B experiment. The KPI impact dashboard can be effective for visualizing how a process or tool change may have impacted core KPIs. Other visualizations are described below.

The experiment system 618 can be used, for example, when an organization is considering rolling out a process change but wants to understand potential effects of the process change. The experiment system 618 can be used to apply experiment methods to the workforce analytics system 602 to allow operations managers, for example, to experiment with processes and determine whether a given proposed process change will likely have a positive effect. The experiment system 618 can take the team member work measurement data reflected in the model produced by the data processing pipeline 616 and use that team member work measurement data to provide a framework for testing the impact of changes made in teams to understand if the changes made a measurable difference in various metrics, either positively or negatively.

Without the experiment system 618, managers who oversee the work done by teams of people do not have methods for measuring the impact of changes in tooling, processes, or personnel on the performance of those teams across the use of a large set of heterogeneous tools. Operations teams want to continuously improve their processes to increase the quality of the service they deliver to customers, but continuous improvement can be challenging when teams do not have a mechanism for measuring the impact of changes. For example, a call center may want to introduce a new application into call center agent toolkits or test a new template for common customer inquiries, but there can be risk to roll out an untested change to all of the agents if the call center does not know if the change(s) will result in an improvement.

The experiment system 618 can provide various advantages as compared to other approaches. For example, the experiment system 618 can measure changes of metrics of workers who are working on a heterogeneous set of tools, in contrast to some systems that may be configured to test one feature of a single web site. The workforce analytics system 618 can collect data from resources (e.g., web pages) that are owned and controlled by an organization and resources or web pages that are not owned by the organization, in contrast to testing that may be based on solutions that require an ability to edit script code of owned resources (which can prohibit measuring use of non-owned resources, for example).

Existing tools may be, for example, specific to a marketing use case and may be designed to help marketers understand how changes on a single webpage owned by the marketer impact a set of marketing metrics such as conversion rate. Such existing marketing tools are not set up to collect metrics from human teams working across many different web pages and tools, some of which are owned by the team (e.g., an internal administration page) and some that are not (e.g., third party collaboration or ticketing tools). The experiment system 618, by using data from the workforce analytics system 602, can perform experiments on data that provides a broad view of team member activity across all of the types of pages and tools that are used for work by human teams.

Existing marketing tools may treat measurements as being related to anonymous external parties (e.g., visitors to a website). The experiment system 618, in contract, can measure activity of internal parties (e.g., workforce personnel). The experiment system 618 can enable segmentation (e.g., into experiment groups and/or control groups) based on known user information such as a job role within the company, manager information, team assignment, or other information provided by an organization or through integration with an identity system such as a directory system.

Other existing approaches can include manual time and motion studies for understanding worker activity. Such time and motion studies are generally performed by a manager watching over the shoulder of a worker with a stopwatch and a clipboard. The presence of a manager may modify the behavior of workers being monitored. As another example, some teams may screen-record all of their agents and review the video to understand team tasks and processes. However, both time and motion studies and review of screen-recorded video are too time consuming to be applied to all workers at a same time so at best managers are reviewing small samples of workers. Time requirements for manual approaches can result in barriers to justifying and running experiments or tests for new processes or tools due to resource cost and time to completion. With the experiment system 618 and the workforce analytics system 602, continuous structured data about all workers can be recorded and automatically used in experiments. A change in activity can be from a change being tested, rather than from a manager manually testing a worker, for example. With the experiment system 618, a manger can spend a few minutes to configure an experiment, and such a relatively small time commitment can make testing process changes feasible that were otherwise infeasible before installation of the experiment system 618.

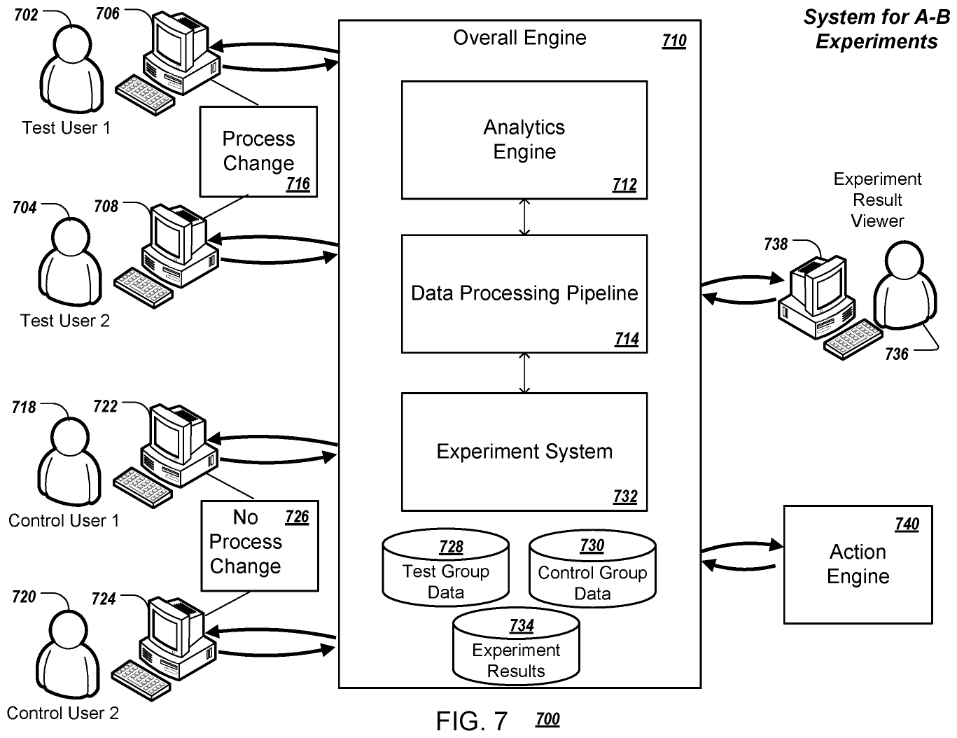

FIG. 7 illustrates an example system 700 for AB experiments. In the system 700, a test group includes at least a first test user 702 and a second test user 704 that respectively use a computing device 706 or a computing device 708 to perform work that is monitored by an engine 710. Specifically, the engine 710 can include an analytics engine 712 (which can be the workforce analytics system 602 described in the previous figure) and a data processing pipeline 714 (which can be the data processing pipeline 616 described in the previous figure) which can monitor user activity and process activity information received for users, respectively.

The first test user 702 and the second test user 704 can perform work with respect to a process change 716 to be tested. The process change 716 can include tools and processes used by the first test user 702 and the second test user 704 while using the tools, for example. The engine 710 can also monitor activity for control group users that include at least a first control user 718 and a second control user 720 that respectively use a computing device 722 or a computing device 724 to perform work. The first control user 718 and the second control user 720 can perform work without the process change 716 (e.g., as illustrated by a “no process change” label 726).

The data processing pipeline 714 can produce test group data 728 and control group data 730 based on activity of users in the test group or the control group, respectively. An experiment system 732 (which can be the experiment system 618 of the previous figure) can generate experiment results 734 based on the test group data 728 and the control group data 730. The experiment results 734 can identify any differences in metrics between the test group and the control group.

A stakeholder user 736 (e.g., a manager) can view the experiment results 734 (and/or visualizations that are generated based on the experiment results 734) using a computing device 738. The stakeholder user 736 may take action based on the experiment results 734. As another example, an action engine 740 may automatically perform one or more actions based on the experiment results 734.

Actions, which can be manual actions taken by the stakeholder user 736 and/or automatic actions performed by the action engine 740, can include deploying the change that was tested to a larger group of users (e.g., all users, or a subset of users that is larger than the test group) based on determining that the experiment was successful. As another example, the change can be rolled back for the test group based on determining that the experiment was not successful. As another example, a next experiment can be initiated using a larger (and/or different) test group. Other actions can include generating and presenting one or more recommendations based on the experiment results 734.

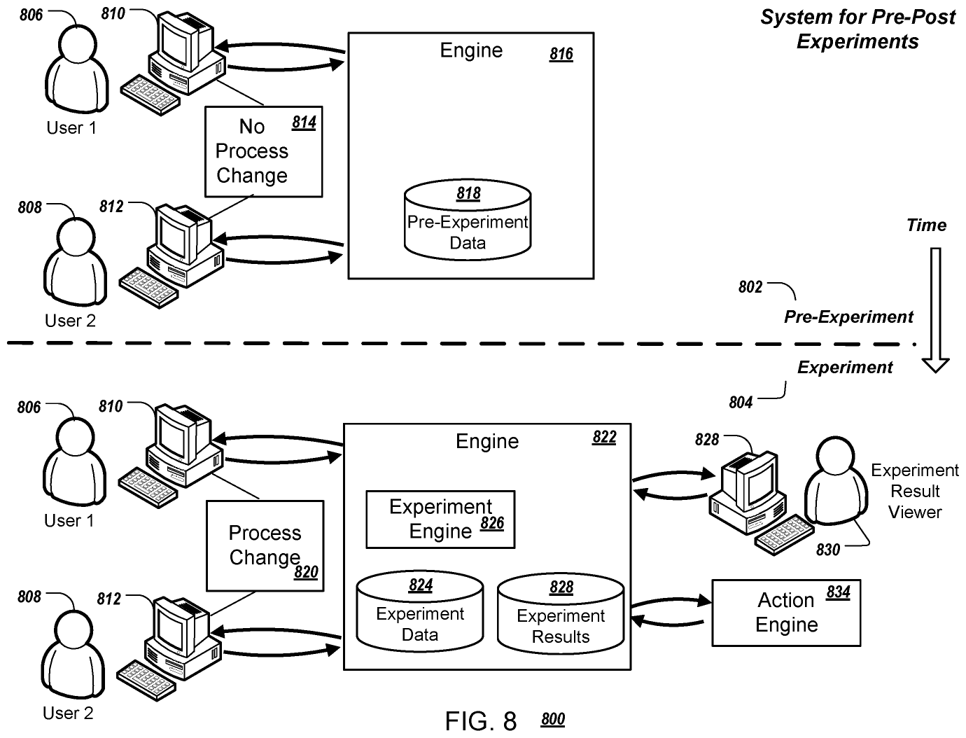

FIG. 8 illustrates an example system 800 for pre-post experiments. FIG. 8 illustrates activity in a pre-experiment time period 802 and in an experiment time period 804. In the pre-experiment time period 802, a group of users performs work before implementation of a change to be tested. For example, the group of users can include a first user 806 and a second user 808 that respectively use a computing device 810 or a computing device 812 to do work. The first user 806 and the second user 808 can perform work without a process change to be tested having been implemented (e.g., as illustrated by a “no process change” label 814). An engine 816 (which can include an analytics engine and a data processing pipeline, as described above) can monitor activity of users in the user group during the pre-experiment time period 802 and generate pre-experiment data 818 for users in the user group.

In the experiment time period 804, the same group of users performs work after implementation of the process change (e.g., as illustrated by a “process change” label 820). For example, during the experiment time period 804, the first user 806 and the second user 808 can perform work after the process change has been implemented. An engine 822 (which can include an analytics engine and a data processing pipeline, as described above) can monitor activity of users in the user group during the experiment time period 804 and generate experiment data 824 for users in the user group.

The engine 822 can include an experiment engine 826 that can generate experiment results 828 that identify differences between the pre-experiment data 818 and the experiment data 824. As described above, a stakeholder user 830 can view experiment results 828 on a computing device 832. As described above, the stakeholder user 830 and/or an action engine 834 can take one or more actions based on the experiment results 828.

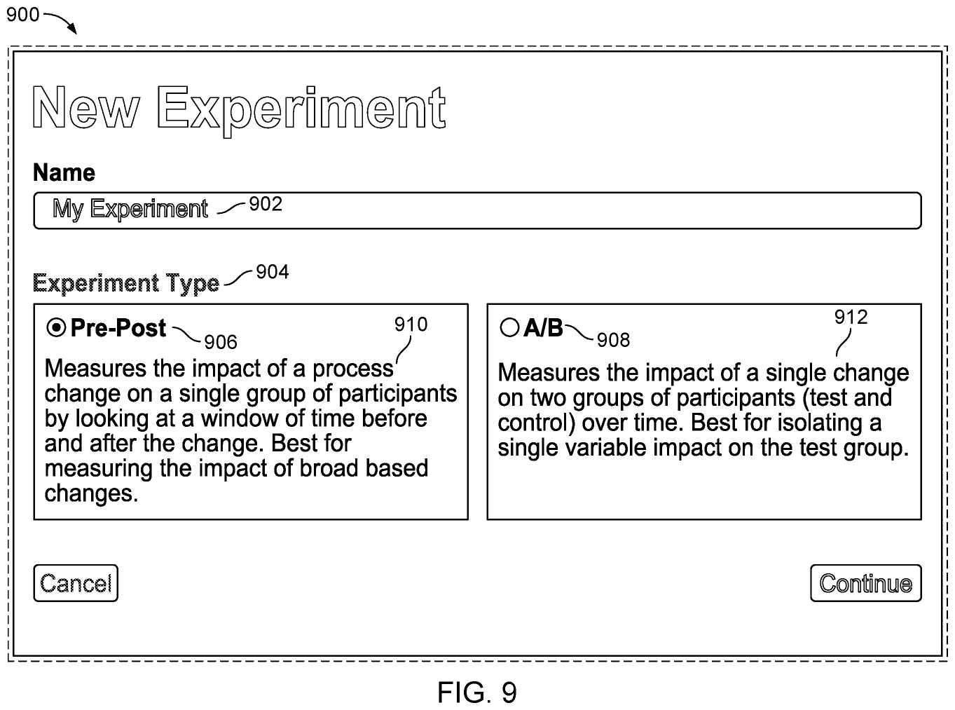

FIG. 9 illustrates an example user interface 900 for starting a new experiment. An experiment name field 902 can be used for entering a name for the new experiment. An experiment type section 904 can be used for selecting a type of experiment to create. For example, a pre-post option 906 can be selected if the user wants to create a pre-post experiment. As another example, an A/B option 908 can be selected if the user wants to create an A/B experiment. As shown, the pre-post option 906 is currently selected.

As described in a note 910, a pre-post experiment can be used to measure an impact of a process change (or a tool or some other type change) on a single group of participants by evaluating a window of time before and after the change. Pre-post experiments may be well suited for measuring the impact of broad-based changes, for example. As described in a note 912, an A/B experiment can be used to measure the impact of a change on two groups of participants over a period of time (e.g., with one group being configured as a test group and the other being configured as a control group). A/B experiments can be well suited for isolating a single-variable impact on the test group.

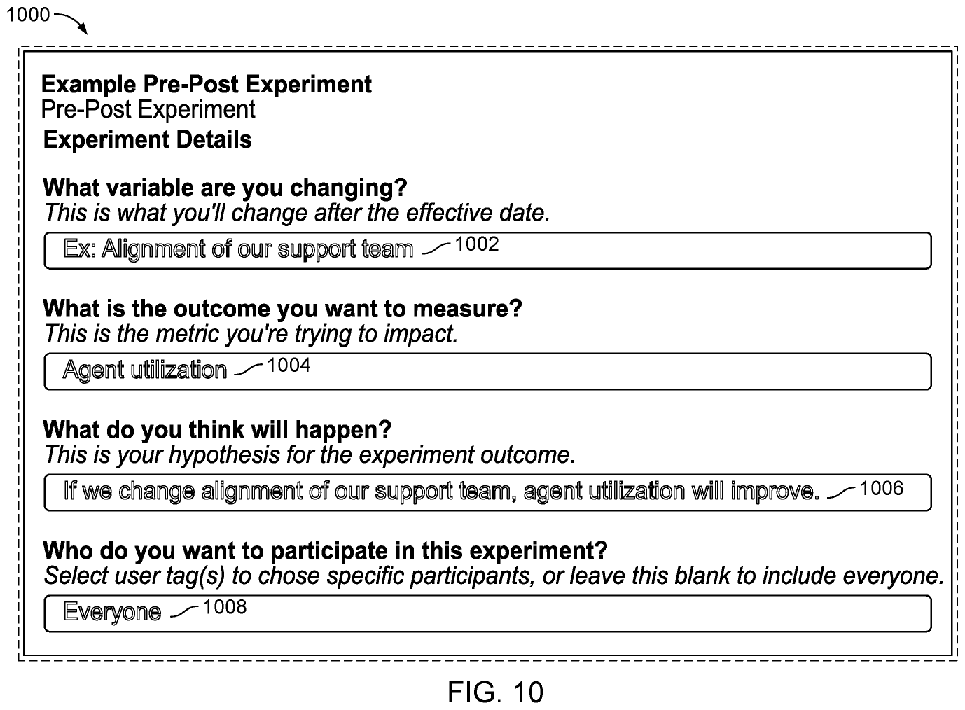

FIG. 10 illustrates an example user interface 1000 for providing experiment details for a pre-post experiment. Pre-post experiments can be used when a team wants to determine the impact of a change across the same group of participants before and after a change was implemented for that group. A pre-post type of experiment can be best for when an organization wants to apply a change to a single group and measure that group against its past performance. As a particular example, the organization may want to understand how a process change for how tasks are distributed to team members might impact team member handle time. The change can be applied to a same cohort of team members and experiment results for the cohort can be compared to corresponding pre-experiment data for the cohort.

Experiment details provided using the user interface 1000 for a pre-post experiment can include information used for conducting an experiment and also for documenting and tracking the experiment. A variable field 1002 can enable a user to provide information about what variable is being changed/tested (e.g., between a pre-experiment time period and an experiment time period for the pre-post experiment). The variable can be a specific process or tool change that is going to be measured for the experiment. The variable can be anything that a team might want to change about a team process or team tool use. A best practice can be to change only one thing at a time for the experiment to ensure that the experiment results capture differences that result from just that change. The change represented by the variable can be adoption of a new tool, rollout of a new response template, a change to team size, a change in training, or any other type of change that affects the team.

An outcome metric field 1004 can enable a user to enter (and/or select) one or more outcome metrics that the user is interested in measuring for the experiment. The experiment system can generate, by default, a core set of metrics related to team performance. In some cases, the outcome metric field 1004 can be used to document which metrics are of interest for the experiment. The outcome metrics can relate to a hypothesis of the experiment.

A hypothesis field 1006 can enable a user to provide information that describes an expected outcome for the experiment. The hypothesis field 1006 enables a user to describe what the user predicts may happen during the course of the experiment. In practice, actual experiment results don't always match expected experiment results, but by documenting expected outcomes up front, the user can be better prepared to analyze and determine reasons for why unexpected results don't match the expected results.

An experiment participants control 1008 can enable a user to enter and/or select certain group(s) of users that are to be included in an experiment. When the experiment has been configured as a pre/post type of experiment, the experiment participants control 1008 can enable the user to select the group(s) that will be participating in a post-change experiment period to be measured against a pre-change period. In some cases, for pre/post experiments, all team members may be selected for the experiment by default. Entering or selecting particular group(s) of users using the participants control 1008 can enable a user to override the default of including all team members in the experiment.

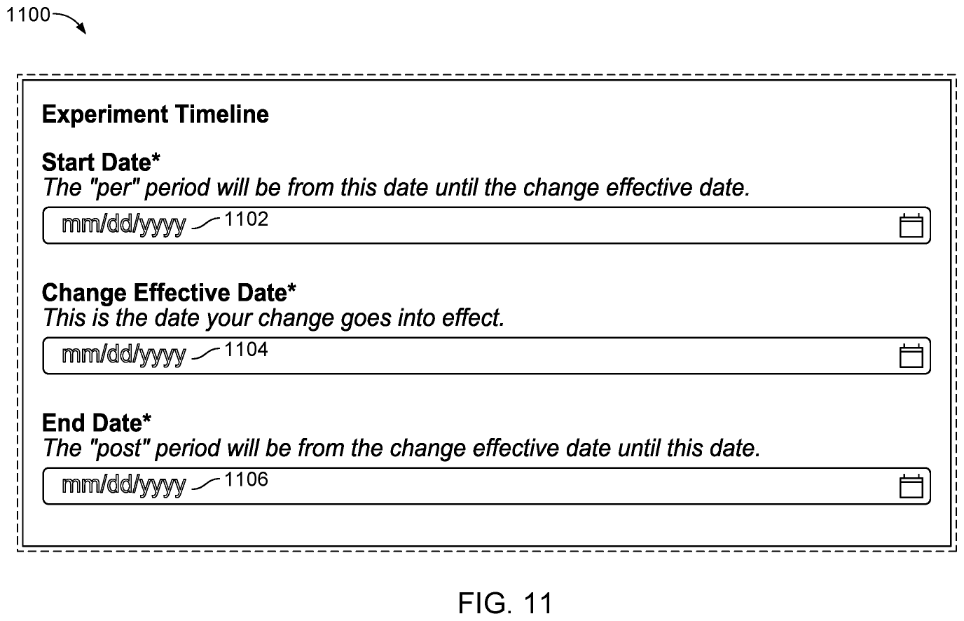

FIG. 11 illustrates an example user interface 1100 for providing information for establishing an experiment timeline for a pre-post experiment. A user can use a start date field 1102 to provide information that identifies a starting date of the experiment. The user can use a change-effective date field 1104 to provide information that identifies a date on which a change to be tested goes into effect. A pre-experiment period for the experiment can be defined as being from the starting date until the change-effective date. An end date field 1106 can be used to provide information that identifies an ending date of the experiment. An experiment period (e.g., “post” period) for the experiment can be defined as being from the change-effective date until the ending date.

In some implementations, various constraints can be enforced for the starting date, change effective date, and/or ending date. For example, the user interface 1100 can be configured to accept a starting date that is any date up to a certain number of days (e.g., 90 days) in the past. As another example, the user interface 1100 can be configured to accept an ending date that can be any date that is after the starting date and up to a certain number of days (e.g., 90 days) after the starting date. A recommended change effective date can be a date that is exactly between the starting date and the ending date. In some implementations, the user interface 1100 is configured to suggest and/or automatically calculate and display a recommend change effective date based on values that have been entered for the starting date and the ending date. In some implementations, the user interface 1100 can warn about (or in some cases prevent) a change effective date that is not substantially equidistant from the starting date and the ending date. In some implementations, the user interface 1100 can warn about (or in some cases prevent) a change effective date that is closer to the starting date than the ending date (or closer to the ending date than the starting date) by more than a certain number of days. For example, if a change effective date selected or entered into the change-effective date field 1104 results in a pre-experiment period being five or more days longer than an experiment period, a warning can be displayed in the user interface 1100.

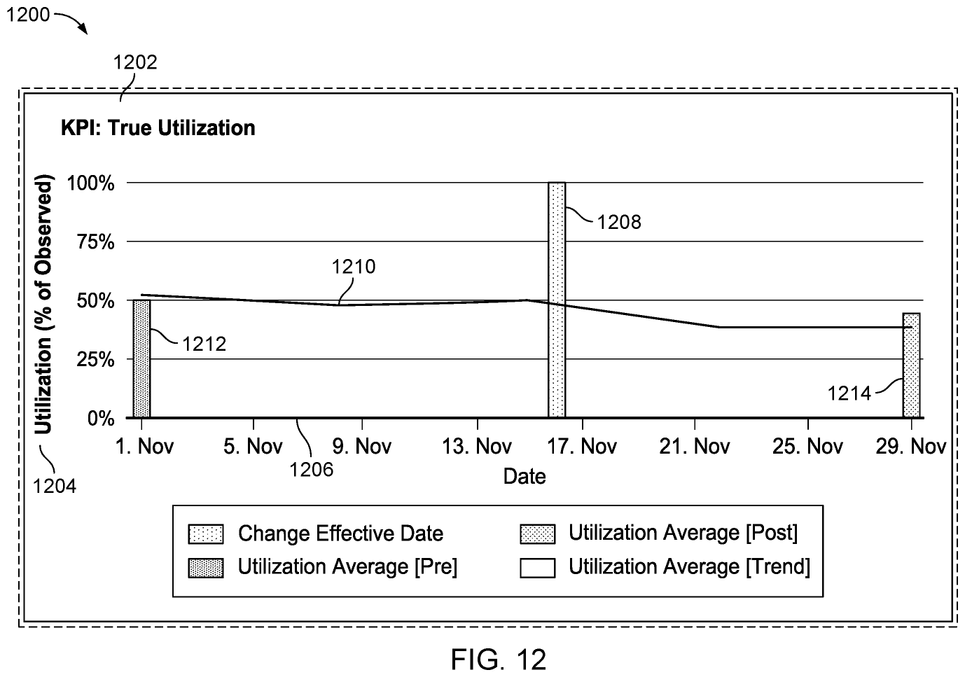

FIG. 12 is an example graph 1200 that depicts experiment results for an example pre-post experiment. The example pre-post experiment was configured to measure an effect of a change (e.g., process and/or tool change) on a true utilization KPI 1202. A Y-axis 1204 corresponds to true utilization values at various pre- and post-experiment times. An X-axis 1206 corresponds to date timestamps, both pre- and post-experiment. For example, a bar 1208 indicates an experiment start date of November 16^{th}. Dates to the left of the bar 1208 correspond to pre-experiment dates and dates on or to the right of the bar 1208 correspond to post-experiment dates.

A graph line 1210 plots average true utilization values for experiment participants, for both pre- and post-experiment dates. A bar 1212 illustrates an average true utilization rate for a pre-experiment time period (e.g., of approximately 50%). A bar 1214 illustrates an average true utilization rate for an experiment period (e.g., of approximately 45%). If the experiment had a hypothesis that a change being tested by the experiment was to increase true utilization rates, then that hypothesis appears to have been inaccurate, at least as reflected by results to date for the experiment. Accordingly, interested parties may choose, after viewing the experiment results displayed in the graph 1200, to test a different type of change or adjust a change being tested (e.g., in a new experiment), wait for more experiment results to be gathered (e.g., extend the experiment) before making a conclusion, roll back the change for the group being tested, or take some other type of action.

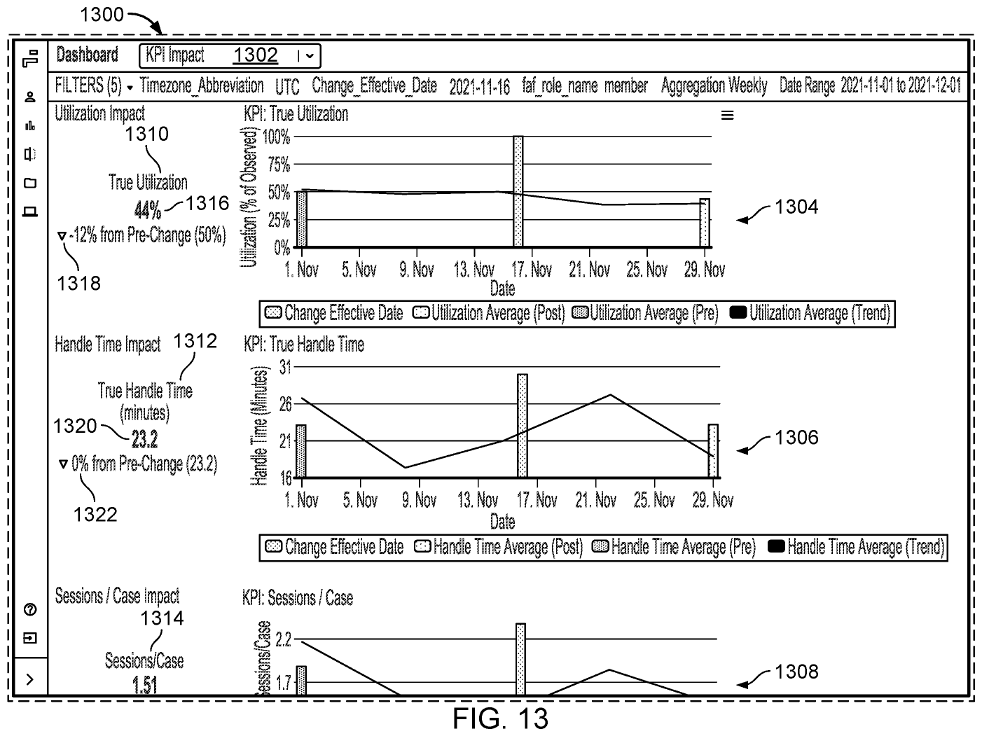

FIG. 13 illustrates an example dashboard user interface 1300 for pre-post experiments. The dashboard user interface 1300 is showing KPI impact information (e.g., in response to user selection of a KPI impact option in a selection control 1302). The dashboard user interface 1300 includes graphs 1304, 1306, and 1308 that show information for a true utilization KPI 1310, a true handle time KPI 1312, and a sessions per case KPI 1314, respectively.

Each graph 1304, 1306, and 1308 includes a graph similar to the graph 1200 described above with respect to FIG. 12. For example, each graph 1304, 1306, and 1308 shows KPI values before and after an experiment start date. Each graph 1304, 1306, and 1308 can also include or be presented along with summary information for the experiment(s) that are measuring effects of a change on a respective KPI. For example, a true utilization experiment average 1316 of 44% is presented with the graph 1304, along with a comparison value 1318 (e.g., down 12%) relative to a pre-experiment average of 50%. As another example, a true handle time experiment average 1320 of 23.2 minutes is presented with the graph 1306, along with a comparison value 1322 (e.g., down 0%) relative to a pre-experiment average that is also 23.2 minutes. Similar information can be presented with the graph 1308 (e.g., similar information for the sessions per case metric 1314 may currently be off-screen but accessible if the user scrolls the dashboard user interface 1300).

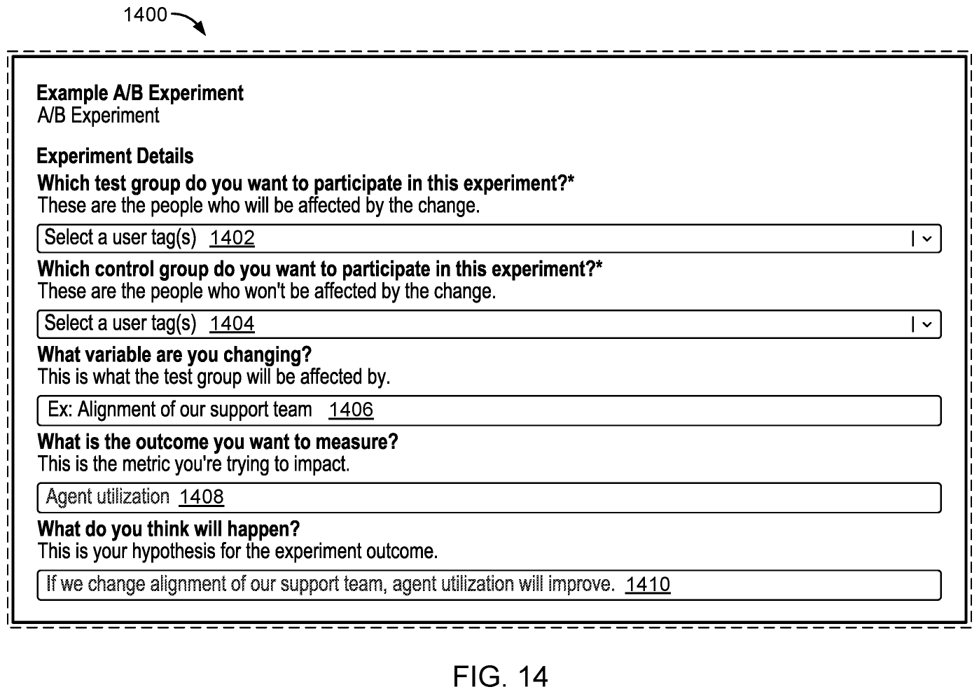

FIG. 14 illustrates an example user interface 1400 for providing experiment details for an A/B experiment. As mentioned, an A/B experiment can enable definition of two groups of experiment participants—an experiment group and a control group. During the experiment, a change is applied to the experiment group and experiment results can be examined to determine how the change may have impacted metrics from the experiment group as compared to corresponding metrics for the control group. If the change improves the metrics for the experiment group, an experiment conclusion can be that the change is a good candidate to roll out to a larger group than the experiment group.

The user interface 1400 includes a test group participant selection control 1402 and a control group participant selection control 1404 that enable the user to enter and/or select certain users or groups of users that are to be included in an experiment in either a test role or a control role. For example, the test group participant selection control 1402 can be used to enter or select user tags and/or user group identifier(s) for users that will be affected by a change that is enacted for the experiment. The control group participant selection control 1404 can be used to enter or select user tags and/or user group identifier(s) for users that will not be affected by the change. Other methods for selecting participants for test and control groups can be used.

A variable field 1406 can enable a user to provide information about what variable(s) are being changed/tested (e.g., between user groups for the A/B experiment). An outcome metric field 1408 can enable a user to enter (and/or select) one or more outcome metrics that the user is interested in measuring for the experiment. A hypothesis field 1410 can enable a user to provide information that describes an expected outcome for the experiment.

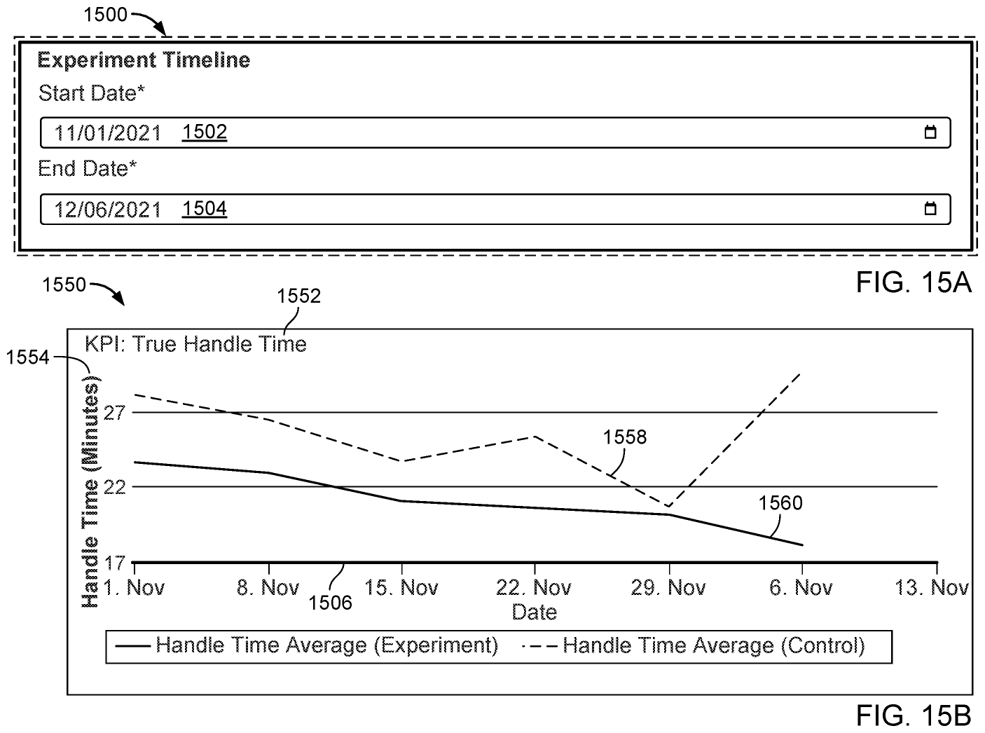

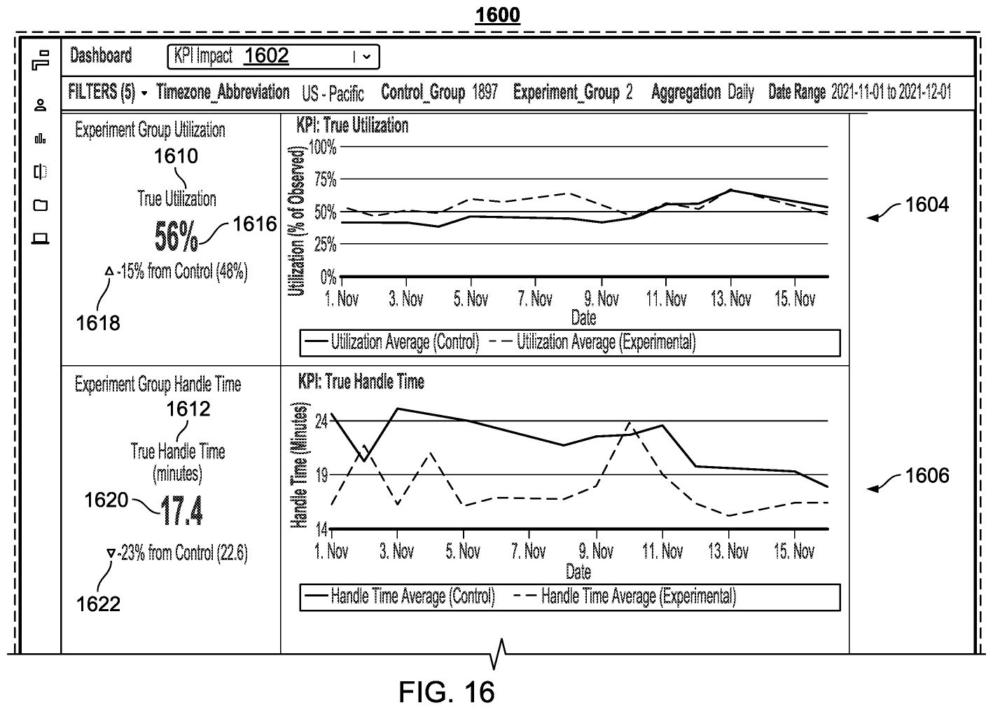

FIG. 15A is an example user interface 1500 for configuring an experiment timeline for an A/B experiment. The user interface 1500 includes a start date field 1502 for configuring an experiment start date and an end date field 1504 for configuring an experiment ending date. In some implementations, various constraints can be enforced for the starting date and/or ending date. For example, the user interface 1500 can be configured to accept a starting date that is any date up to a certain number of days (e.g., 90 days) in the past. As another example, the user interface 1500 can be configured to accept an ending date that can be any date that is after the starting date and up to a certain number of days (e.g., 90 days) after the starting date.

FIG. 15B is an example graph 1550 that depicts experiment results for an example A/B experiment. The example A/B experiment was configured to measure an effect of a change (e.g., process and/or tool change) on a true handle time KPI 1552. A Y-axis 1554 corresponds to average true handle time values. An X-axis 1556 corresponds to dates on which average true handle time was measured for both a test group and a control group.

For example, a control line 1558 plots average true handle time values for the control group for dates of the experiment. An experiment line 1560 plots average true handle time values for the test group for the dates of the experiment. As shown in the graph 1550, the average true handle times for the control group are generally higher than the average true handle times for the experiment group. If a hypothesis of the experiment was that the change may reduce true handle time, then the experiment results appear to support that hypothesis. Accordingly, one or more actions can be performed, such as to automatically deploy or enact the change for a larger group of users (e.g., a group larger than the experiment group), extend the experiment to see if results continue to hold for a longer time period, conduct another experiment, stop the current experiment, or take one or more other types of actions.

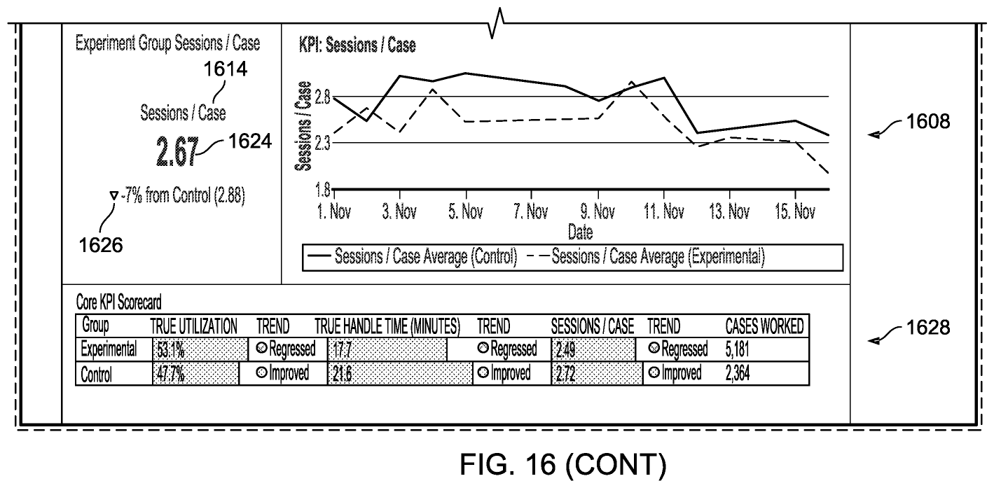

FIG. 16 illustrates an example dashboard user interface 1600 for A/B experiments. The dashboard user interface 1600 is showing KPI impact information (e.g., in response to user selection of a KPI impact option in a selection control 1602). The dashboard user interface 1600 includes graphs 1604, 1606, and 1608 that show information for a true utilization KPI 1610, a true handle time KPI 1612, and a sessions per case KPI 1614, respectively.

Each graph 1604, 1606, and 1608 includes a graph similar to the graph 1550 described above with respect to FIG. 15B. For example, each graph 1604, 1606, and 1608 shows KPI values for both a test group and a control group. Each graph 1604, 1606, and 1608 can also include or be presented along with summary information for the experiment(s) that are measuring effects of a change on a respective KPI. For example, a true utilization experiment group average 1616 of 56% is presented with the graph 1604, along with a comparison value 1618 (e.g., up 15%) relative to a control group average of 48%. As another example, a true handle time experiment group average 1620 of 17.4 minutes is presented with the graph 1606, along with a comparison value 1622 (e.g., down 23%) relative to a control group average of 22.6 minutes. As yet another example, a sessions per case experiment group average 1624 of 2.67 is presented with the graph 1606, along with a comparison value 1626 (e.g., down 7%) relative to a test group average of 2.88.

The dashboard user interface 1600 also includes a core KPI scorecard area 1628. The core KPI scorecard area 1628 shows experiment and control summary information for each of the true utilization KPI 1610, the true handle time KPI 1612, and the sessions per case KPI 1614 that includes experiment and control group measurements and an indication as to whether the experiment group or the control has regressed or improved with respect to the respective KPI's.

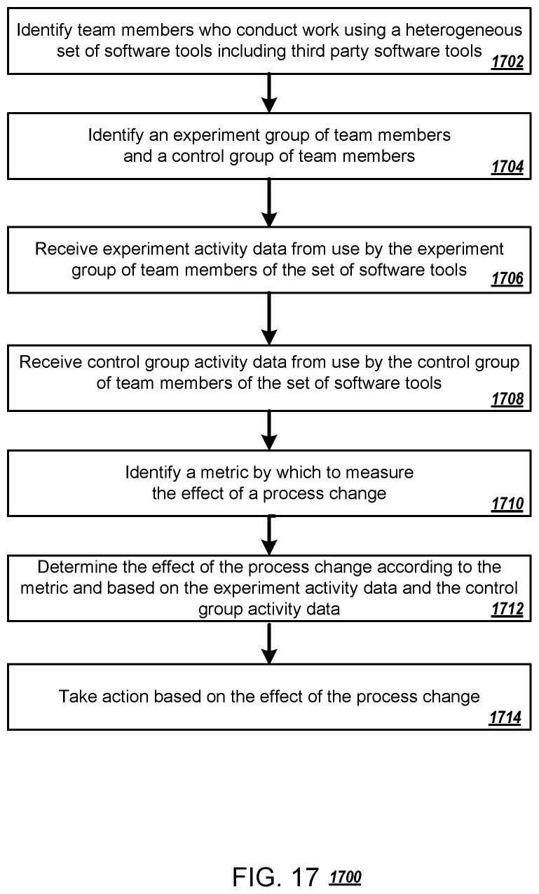

FIG. 17 is a flowchart of an example of a method 1700 for performing an experiment for a workforce analytics system. For example, the system 200 can be used to perform the method 1700. For clarity of presentation, the description that follows generally describes method 1700 in the context of the other figures in this description. However, it will be understood that method 1700 can be performed, for example, by any suitable system, environment, software, and hardware, or a combination of systems, environments, software, and hardware, as appropriate. In some implementations, various steps of method 1700 can be run in parallel, in combination, in loops, or in any order.

At 1702, team members are identified who conduct work using a heterogeneous set of software tools including third party software tools. The heterogeneous set of software tools can include, for example, web pages, documents, spreadsheets, workflows, desktop applications, and conversations on communication devices.

At 1704, an experiment group of team members and a control group of team members are identified, based on inclusion criteria for an experiment. The experiment group of team members can be same group of team members as the control group of team members or can be a different group of team members.

At 1706, experiment activity data is received from use by the experiment group of team members of the set of software tools. When the control group of team members and the experiment group of team members are the same set of team members, the experiment activity data can be received before a process change occurs that is being measured by the experiment.

At 1708, control group activity data is received from use by the control group of team members of the set of software tools. When the control group of team members and the experiment group of team members are the same set of team members, the control group activity data can be data that is generated before implementation of the process change. Both the experiment activity data and the control group activity data can include interactions by team members using the heterogeneous set of software tools while working on one or more cases being handled by a respective team member.

At 1710, a metric by which to measure the effect of the process change is identified. In some cases multiple metrics are identified. Metrics can include, for example, one or more of a true utilization metric that measures a proportion of available team member time spent productively working on cases, a true handle time metric that measures an average amount of team member time spent on a case, or a sessions per case metric that measures an average number of sessions spent by team members per case resolution. The process change can be team member use of a new process for using the heterogeneous set of software tools. As a particular example, the process change can be use by team members of a new software tool that has been added to the heterogeneous set of software tools.

At 1712, the effect of the process change is determined according to the metric and based on the experiment activity data and the control group activity data.

At 1714, action is taken based on the effect of the process change. Taking action can include, for example, generating a recommendation regarding deployment of the process change beyond the experiment group and providing the recommendation (e.g., to a responsible manager or other stakeholders). As another example, taking action can include automatically deploying the process change to other team members not in the experiment group. In some cases, the process change can be automatically deployed in response to determining that the value of the process change is greater than a predetermined threshold. As another example, in some cases, taking action can include automatically rolling back the process change for the experiment group in response to determining that the value of the process change is less than a predetermined threshold.

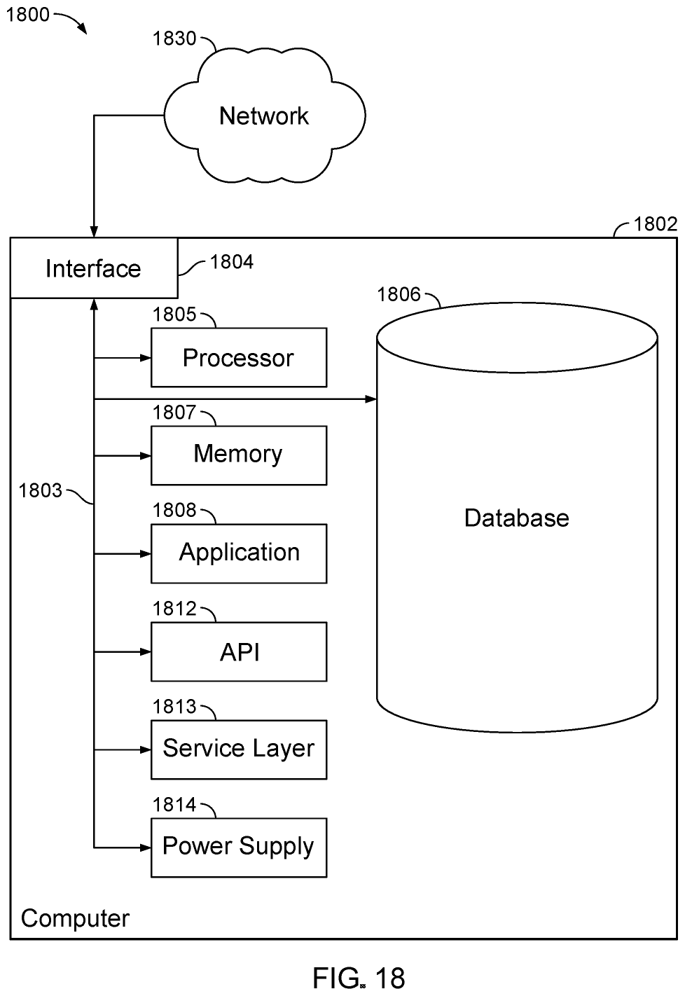

FIG. 18 is a block diagram of an example computer system 1800 used to provide computational functionalities associated with described algorithms, methods, functions, processes, flows, and procedures described in the present disclosure, according to some implementations of the present disclosure. The illustrated computer 1802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1802 can include input devices such as keypads, keyboards, and touch screens that can accept user information. Also, the computer 1802 can include output devices that can convey information associated with the operation of the computer 1802. The information can include digital data, visual data, audio information, or a combination of information. The information can be presented in a graphical user interface (UI) (or GUI).

The computer 1802 can serve in a role as a client, a network component, a server, a database, a persistency, or components of a computer system for performing the subject matter described in the present disclosure. The illustrated computer 1802 is communicably coupled with a network 1830. In some implementations, one or more components of the computer 1802 can be configured to operate within different environments, including cloud-computing-based environments, local environments, global environments, and combinations of environments.

At a top level, the computer 1802 is an electronic computing device operable to receive, transmit, process, store, and manage data and information associated with the described subject matter. According to some implementations, the computer 1802 can also include, or be communicably coupled with, an application server, an email server, a web server, a caching server, a streaming data server, or a combination of servers.

The computer 1802 can receive requests over network 1830 from a client application (for example, executing on another computer 1802). The computer 1802 can respond to the received requests by processing the received requests using software applications. Requests can also be sent to the computer 1802 from internal users (for example, from a command console), external (or third) parties, automated applications, entities, individuals, systems, and computers.

Each of the components of the computer 1802 can communicate using a system bus 1803. In some implementations, any or all of the components of the computer 1802, including hardware or software components, can interface with each other or the interface 1804 (or a combination of both) over the system bus 1803. Interfaces can use an application programming interface (API) 1812, a service layer 1813, or a combination of the API 1812 and service layer 1813. The API 1812 can include specifications for routines, data structures, and object classes. The API 1812 can be either computer-language independent or dependent. The API 1812 can refer to a complete interface, a single function, or a set of APIs.

The service layer 1813 can provide software services to the computer 1802 and other components (whether illustrated or not) that are communicably coupled to the computer 1802. The functionality of the computer 1802 can be accessible for all service consumers using this service layer. Software services, such as those provided by the service layer 1813, can provide reusable, defined functionalities through a defined interface. For example, the interface can be software written in JAVA, C++, or a language providing data in extensible markup language (XML) format. While illustrated as an integrated component of the computer 1802, in alternative implementations, the API 1812 or the service layer 1813 can be stand-alone components in relation to other components of the computer 1802 and other components communicably coupled to the computer 1802. Moreover, any or all parts of the API 1812 or the service layer 1813 can be implemented as child or sub-modules of another software module, enterprise application, or hardware module without departing from the scope of the present disclosure.

The computer 1802 includes an interface 1804. Although illustrated as a single interface 1804 in FIG. 18, two or more interfaces 1804 can be used according to particular needs, desires, or particular implementations of the computer 1802 and the described functionality. The interface 1804 can be used by the computer 1802 for communicating with other systems that are connected to the network 1830 (whether illustrated or not) in a distributed environment. Generally, the interface 1804 can include, or be implemented using, logic encoded in software or hardware (or a combination of software and hardware) operable to communicate with the network 1830. More specifically, the interface 1804 can include software supporting one or more communication protocols associated with communications. As such, the network 1830 or the interface's hardware can be operable to communicate physical signals within and outside of the illustrated computer 1802.

The computer 1802 includes a processor 1805. Although illustrated as a single processor 1805 in FIG. 18, two or more processors 1805 can be used according to particular needs, desires, or particular implementations of the computer 1802 and the described functionality. Generally, the processor 1805 can execute instructions and can manipulate data to perform the operations of the computer 1802, including operations using algorithms, methods, functions, processes, flows, and procedures as described in the present disclosure.

The computer 1802 also includes a database 1806 that can hold data for the computer 1802 and other components connected to the network 1830 (whether illustrated or not). For example, database 1806 can be an in-memory, conventional, or a database storing data consistent with the present disclosure. In some implementations, database 1806 can be a combination of two or more different database types (for example, hybrid in-memory and conventional databases) according to particular needs, desires, or particular implementations of the computer 1802 and the described functionality. Although illustrated as a single database 1806 in FIG. 18, two or more databases (of the same, different, or combination of types) can be used according to particular needs, desires, or particular implementations of the computer 1802 and the described functionality. While database 1806 is illustrated as an internal component of the computer 1802, in alternative implementations, database 1806 can be external to the computer 1802.

The computer 1802 also includes a memory 1807 that can hold data for the computer 1802 or a combination of components connected to the network 1830 (whether illustrated or not). Memory 1807 can store any data consistent with the present disclosure. In some implementations, memory 1807 can be a combination of two or more different types of memory (for example, a combination of semiconductor and magnetic storage) according to particular needs, desires, or particular implementations of the computer 1802 and the described functionality. Although illustrated as a single memory 1807 in FIG. 18, two or more memories 1807 (of the same, different, or combination of types) can be used according to particular needs, desires, or particular implementations of the computer 1802 and the described functionality. While memory 1807 is illustrated as an internal component of the computer 1802, in alternative implementations, memory 1807 can be external to the computer 1802.

The application 1808 can be an algorithmic software engine providing functionality according to particular needs, desires, or particular implementations of the computer 1802 and the described functionality. For example, application 1808 can serve as one or more components, modules, or applications. Further, although illustrated as a single application 1808, the application 1808 can be implemented as multiple applications 1808 on the computer 1802. In addition, although illustrated as internal to the computer 1802, in alternative implementations, the application 1808 can be external to the computer 1802.

The computer 1802 can also include a power supply 1814. The power supply 1814 can include a rechargeable or non-rechargeable battery that can be configured to be either user- or non-user-replaceable. In some implementations, the power supply 1814 can include power-conversion and management circuits, including recharging, standby, and power management functionalities. In some implementations, the power-supply 1814 can include a power plug to allow the computer 1802 to be plugged into a wall socket or a power source to, for example, power the computer 1802 or recharge a rechargeable battery.

There can be any number of computers 1802 associated with, or external to, a computer system containing computer 1802, with each computer 1802 communicating over network 1830. Further, the terms “client,” “user,” and other appropriate terminology can be used interchangeably, as appropriate, without departing from the scope of the present disclosure. Moreover, the present disclosure contemplates that many users can use one computer 1802 and one user can use multiple computers 1802.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
identifying team members who conduct work using a heterogeneous set of software tools including third party software tools;
identifying, based on inclusion criteria for an experiment, an experiment group of team members and a control group of team members;
receiving experiment activity data from use by the experiment group of team members of the heterogeneous set of software tools;
receiving control group activity data from use by the control group of team members of the heterogeneous set of software tools;
identifying a metric by which to measure an effect of a process change;
determining the effect of the process change according to the metric and based on the experiment activity data and the control group activity data; and
taking action based on the effect of the process change.

2. The computer-implemented method of claim 1, wherein the process change comprises team member use of a new software tool.

3. The computer-implemented method of claim 1, wherein the process change comprises team member use of a new process for using the heterogeneous set of software tools.

4. The computer-implemented method of claim 1, wherein the control group of team members includes different team members than the experiment group of team members.

5. The computer-implemented method of claim 1, wherein:
the control group of team members and the experiment group of team members are the same set of team members; and
receiving the control group activity data comprises receiving activity data for activity that occurs by the same set of team members during a time period before implementation of the process change.

6. The computer-implemented method of claim 1, wherein the heterogeneous set of software tools include web pages, documents, spreadsheets, workflows, desktop applications, and conversations on communication devices.

7. The computer-implemented method of claim 1, wherein the experiment activity data and the control group activity data comprise interactions by team members using the heterogeneous set of software tools while working on one or more cases being handled by a respective team member.

8. The computer-implemented method of claim 7, wherein the metric is a true utilization metric that measures a proportion of available team member time spent productively working on cases.

9. The computer-implemented method of claim 7, wherein the metric is a true handle time metric that measures an average amount of team member time spent on a case.

10. The computer-implemented method of claim 7, wherein the metric is a sessions per case metric that measures an average number of sessions spent by team members per case resolution.

11. The computer-implemented method of claim 1, wherein taking action comprises:
generating a recommendation regarding deployment of the process change beyond the experiment group; and
providing the recommendation.

12. The computer-implemented method of claim 1, wherein taking action comprises automatically deploying the process change to other team members not in the experiment group.

13. The computer-implemented method of claim 12, wherein the process change is automatically deployed in response to determining that a value of the process change is greater than a predetermined threshold.

14. The computer-implemented method of claim 1, wherein taking action comprises automatically rolling back the process change for the experiment group in response to determining that the effect of the process change is less than a predetermined threshold.

15. The computer-implemented method of claim 1, wherein a plurality of metrics are identified by which to measure the effect of the process change.

16. The computer-implemented method of claim 1, wherein at least part of the experiment activity data and the control group activity data are received from a browser extension.

17. The computer-implemented method of claim 1, wherein at least part of the experiment activity data and the control group activity data are received from at least one desktop application extension.

18. One or more computer-readable storage media encoded with instructions that, when executed by one or more computers, cause the one or more computers to perform operations comprising:
identifying team members who conduct work using a heterogeneous set of software tools including third party software tools;
identifying, based on inclusion criteria for an experiment, an experiment group of team members and a control group of team members;
receiving experiment activity data from use by the experiment group of team members of the heterogeneous set of software tools;
receiving control group activity data from use by the control group of team members of the heterogeneous set of software tools;
identifying a metric by which to measure the effect of a process change;
determining the effect of the process change according to the metric and based on the experiment activity data and the control group activity data; and
taking action based on the effect of the process change.

19. The computer-implemented method of claim 1, wherein the process change comprises team member use of a new software tool.

20. A system comprising:
one or more computers and one or more storage devices on which are stored instructions that are operable, when executed by the one or more computers, to cause the one or more computers to perform operations comprising:
identifying team members who conduct work using a heterogeneous set of software tools including third party software tools;
identifying, based on inclusion criteria for an experiment, an experiment group of team members and a control group of team members;
receiving experiment activity data from use by the experiment group of team members of the heterogeneous set of software tools;
receiving control group activity data from use by the control group of team members of the heterogeneous set of software tools;
identifying a metric by which to measure the effect of a process change;
determining the effect of the process change according to the metric and based on the experiment activity data and the control group activity data; and
taking action based on the effect of the process change.
